(19) United States
(12) Patent Application Publication
(10) Pub. No.: US 2006/0251275 A1
(43) Pub. Date: Nov. 9, 2006

(54) Output circuit for use with musical instruments

(76) Inventor: Donald E. Ackley, Cardiff, CA (US)

Correspondence Address: ROBERT A. PARSONS, 4000 N. CENTRAL AVENUE, SUITE 1220, PHOENIX, AZ, 85012, US

(21) Appl. No.: 11/121,676

(22) Filed: May 4, 2005

(51) Int. Cl. G10H 1/00

(52) U.S. Cl. 381/118

(57) ABSTRACT

An attenuation circuit is disclosed that is adapted to be electrically connected between an output stage of a guitar amplifier and a speaker. The attenuation circuit includes a plurality of passive components including a series resistor, a parallel resistor, and an inductance. The series resistor, the parallel resistor, and the inductance are coupled to connect the series resistor in series between the output stage of the guitar amplifier and the speaker, to connect the parallel resistor in series with the inductance, and to connect the series connected parallel resistor and the inductance in parallel with the speaker to present a constant resistive impedance to said output stage and to attenuate power delivered from the output stage to the speaker.

### FIELD OF THE INVENTION

This invention relates in general to amplifiers used with musical instruments and, more particularly, to guitar amplifiers.

### BACKGROUND OF THE INVENTION

Musicians' amplifiers, and more specifically, guitar amplifiers, have been used for over 50 years to amplify the sound of instruments. In the case of guitar amplifiers, the function of the amplifier has gone far beyond its original purpose of increasing the volume of a basically acoustic instrument and become an integral part of the sound of the electric guitar. Specifically, the loud, distorted sound typified by the large Marshall and Fender tube amplifier stacks has become synonymous with the sound of rock and roll guitar. However, for purposes of duplicating these sounds at low volumes for use in small venues or for practice, these large amplifiers are wholly impractical. Indeed, for most uses, the large tube amplifiers have been replaced by smaller, lighter, more reliable and much more efficient solid state amplifiers.

Numerous attempts have been made to duplicate the sound of the large tube amplifiers in these smaller solid state amplifiers. Most of these designs have centered on introducing distortion into the early stages of the multi-stage amplifier, predominantly by providing very high gain in the first amplifier stages and thus producing distortion in the following stages. These techniques are applied in different forms in almost all modern guitar amplifiers and are often described as distortion, overdrive, or sustain channels. These techniques are also applied in so-called “effects boxes” which can be implemented between the guitar and the input of the amplifier to achieve distortion, overdrive, compression and numerous other effects. However, none of these techniques have succeeded in emulating the sound of large tube amplifiers played at high volume, with overdriven output stages.

There have been a few attempts to allow overdriven output stages at low volume for the purposes of achieving the sound of large tube amplifiers. Specifically, these techniques have involved placing attenuators between the output of the amplifier and the speaker. For example, Sholz teaches in U.S. Pat. Nos. 4,363,934 and 4,143,245 the use of resistor networks or potentiometers to provide attenuation of an amplified signal before it is delivered to a speaker. Similarly, Pritchard teaches in U.S. Pat. No. 6,631,195 an attenuator with more attenuation of the treble signal than the bass signal to better match the frequency response of the human ear. Pittman teaches in U.S. Pat. No. 4,937,874 more complex means for controlling the output of an amplifier and emulating a speaker before the sound is delivered to a set of headphones or a recording console. There have also been other products placed on the market, such as the THD Hotplate, which provide a reactive load to suitably attenuate the power output of large tube amplifiers.

None of these techniques, however, simultaneously address the critical parameters for emulating loud, distorted sound in a small solid state amplifier. The first parameter to be noted is that solid state amplifiers, in contrast to tube amplifiers, use a direct coupled output instead of a transformer coupled output, and thus prefer to see a constant resistive load instead of a reactive load as argued for tube amplifiers. This is especially important when the output stage is operated at maximum power in conjunction with an output attenuator. Thus, a means for providing a constant resistive load to an amplifier of this type improves the efficiency and audio quality of the amplifier over directly coupling to a speaker.

Second, guitar amplifiers always tend to deliver enhanced bass response. This results from the fact that they generally utilize single speakers with limited high frequency transduction, as opposed to high fidelity speaker systems which utilize multiple speakers and cross-over networks to extend the high frequency range. These speakers routinely have resonances in the 100 Hz frequency range which can make them sound, if anything, boomy at low frequencies. Guitar players routinely operate their guitars and set up the tone controls on their amplifiers to enhance as much as possible the treble or high frequency response. In addition, most guitar amplifiers provide a bright function which further boosts the treble response over the nominal tone control networks.

Third, a key factor in achieving good guitar sound and playability is the attack, here defined as the responsiveness of the guitar sound to the picking of a guitar string. This attack is suppressed at low volumes due to the poor high frequency response of the human ear. As fast attack contains many high frequency components, it is easy to see why suppressing high frequencies can result in poor attack.

These three factors generally contribute to an overall poor, commonly described as “muddy”, sound in most guitar amplifiers at low volumes. A means of improving the sound of guitar amplifiers is therefore desirable.

It would be highly advantageous, therefore, to remedy the foregoing and other deficiencies inherent in the prior art.

Accordingly, it is an object of the present invention to provide a new and improved output attenuator that alleviates the muddy sound and poor attack commonly seen in guitar amplifiers played at low volume.

Another object of the invention is to provide new and improved circuitry that presents a constant impedance to the output stage of a guitar amplifier to improve the efficiency and safety of operation of the output stage when operated at maximum power to introduce output distortion and improve the sound of the guitar amplifier.

### SUMMARY OF THE INVENTION

Briefly, to achieve the desired objects of the instant invention in accordance with a preferred embodiment thereof, provided is an attenuator that includes means to control the attenuation and high frequency response so as to optimize performance with different guitar amplifiers. In a specific embodiment an attenuation circuit is adapted to be electrically connected between an output stage of a guitar amplifier and a speaker. The attenuation circuit includes a plurality of passive components including a series resistor, a parallel resistor, and an inductance. The series resistor, the parallel resistor, and the inductance are coupled to connect the series resistor in series between the output stage of the guitar amplifier and the speaker, to connect the parallel resistor in series with the inductance, and to connect the series connected parallel resistor and the inductance in parallel with the speaker to present a constant resistive impedance to said output stage and to attenuate power delivered from the output stage to the speaker.

In other embodiments a plurality of series resistors, a plurality of parallel resistors, a plurality of inductors, and one or more switches are interconnected to provide a plurality of levels. The resistors and inductors can be variable (e.g. potentiometers), instead of using a plurality, to provide a continuous smooth change. The plurality of inductors, or variable inductor, can be used to change the high frequency power applied to the speaker (i.e. the high frequency enhancement).

The desired objects and purposes of the present invention are further realized in another aspect of the invention in which the high frequency enhancement is used to improve the attack simultaneously as the attenuator reduces the power delivered to the speaker.

In yet another aspect of the invention, the attenuator is contained in a simple enclosure and readily inserted between the output stage of the amplifier and the speaker using the spade connectors on the speaker wires.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is an electrical schematic representation of a typical musical speaker;

FIG. 2 illustrates graphically the impedance of a typical speaker as simulated in a SPICE simulation package;

FIG. 3 illustrates graphically a simulation of power transferred to the typical speaker by an amplifier;

FIG. 4 illustrates graphically contours of constant loudness first measured by Fletcher and Munson in 1933, as presented by Plate-to-Plate Music Electronics;

FIG. 5 is a schematic diagram of an attenuation circuit in accordance with the present invention;

FIG. 7 illustrates graphically a simulation of the power transferred to a speaker through the attenuation circuit of FIG. 5;

FIG. 8 illustrates graphically a simulation of the power transferred to a speaker through an attenuation circuit with additional attenuation in accordance with the present invention;

FIG. 9 illustrates graphically a simulation of the power transferred to the speaker using different values of inductance in the attenuation circuit;

FIG. 10 is a schematic diagram of an attenuation circuit, with two modes of operation, in accordance with the present invention;

FIG. 11 illustrates graphically a simulation of the power transferred to the speaker by the attenuation circuit of FIG. 10 in each of the two modes;

FIG. 12 is a schematic diagram of another attenuation circuit, with two modes of operation, in accordance with the present invention;

FIG. 13 is a schematic diagram of another attenuation circuit, with two modes of operation, in accordance with the present invention;

FIG. 14 illustrates graphically the simulated impedance of the attenuation circuit of FIG. 13 in each of the two modes;

FIG. 15 illustrates graphically the power transferred by the attenuation circuit of FIG. 13 in each of the two modes; and

FIG. 16 is a pictorial view illustrating a reduction to practice of an attenuation circuit in accordance with the present invention.

### DETAILED DESCRIPTION OF THE DRAWINGS

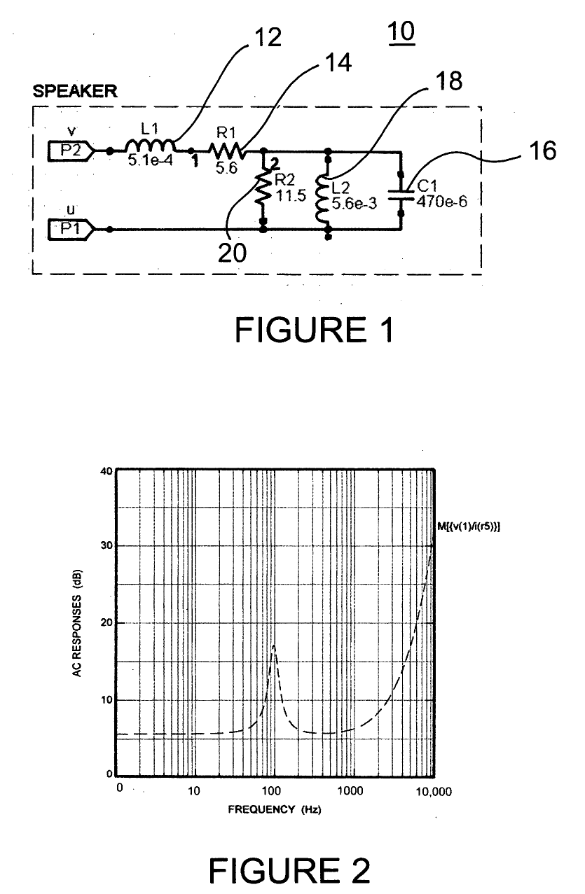

Turning now to the drawings, attention is first directed to FIG. 1, which illustrates a circuit simulation of a typical guitar speaker 10. This simulation models such parameters as the resistance and inductance of the speaker coils and the apparent capacitance introduced by the interaction of speaker 10 with an enclosure. The simulation includes an inductance 12 connected in series with a resistance 14 and a capacitance 16 between one input designated P2 and the other input designated P1. An inductance 18 and a resistance 20 are connected in parallel with capacitance 16. In this specific speaker, the various components have the following approximate values: inductance 12 is 5.1 millihenries; resistance 14 is 5.6 ohms; capacitance 16 is 470 microfarads; inductance 16 is 5.6 millihenries; and resistance 20 is 11.5 ohms.

A calculation of the impedance characteristic of speaker 10 as a function of frequency is illustrated graphically in FIG. 2. There may be seen two salient features in the impedance characteristic. First, there is a resonance at about 100 Hz in the impedance characteristic. This resonance, typical of all speakers, helps to yield the “muddy” or “boomy” sound often associated with small guitar amplifiers. In high fidelity sound equipment this resonance is typically pushed to lower frequencies through a combination of speaker and enclosure design and the use of multiple speakers. However, particularly in a small guitar amplifier system where there is only a single, relatively small 8″or 10″ speaker, this resonance is typically around 100 Hz where its contribution to the bass response of the amplifier is quite evident.

The second important feature in the impedance characteristic of speaker 10 is a strong increase in impedance of the speaker at frequencies above 1000 Hz. This is driven by the inductance of the speaker coil, and severely limits the high frequency response of speaker 10. Once again, in high fidelity speaker systems this characteristic is mitigated by the use of one or multiple smaller speakers with lower inductance and increased compliance in order to improve the high frequency response of the speaker system. This practice is not followed in small guitar amplifier systems of the sort discussed herein, and thus opens up an opportunity to improve the sound of such an amplifier/speaker by enhancing the high frequency power transferred to the speaker.

It is important to note that the impedance of this nominal 8 ohm speaker (e.g. speaker 10) is variable over the frequency range. While historically tube guitar amplifiers have utilized transformer coupling, modern solid state guitar amplifiers use direct coupling of the output stage to the speaker. It would therefore be desirable for the output stage of the solid state amplifier to see as constant a load as possible, as it is well known in the art the a variable load impedance can effect not only the performance of the output stage of the solid state amplifier but of the stages proceeding it.

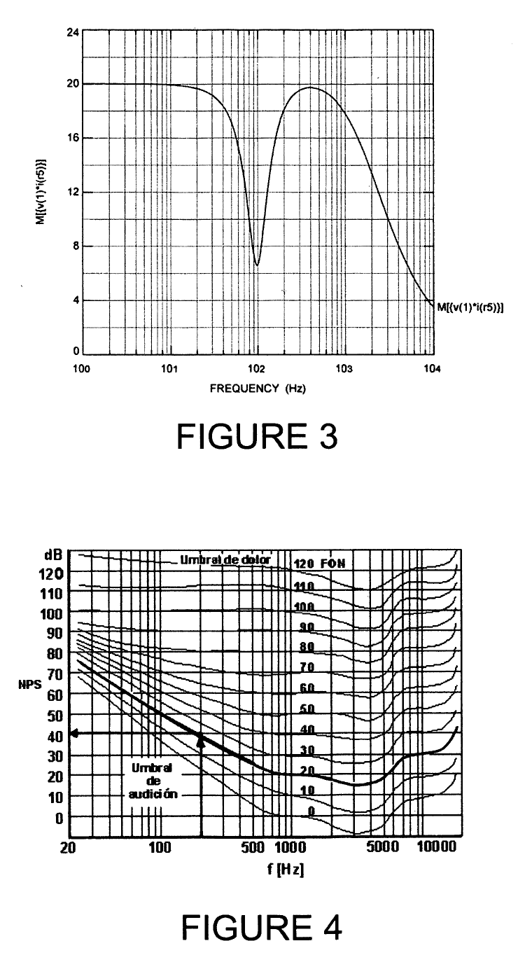

Referring to FIG. 3, the relative power transferred to speaker 10 by a simulated wide frequency power amplifier is illustrated graphically. It is evident that at high frequencies, the power transferred to speaker 10 is severely reduced leading to the poor high frequency characteristics observed in small guitar amplifier systems.

Turning to FIG. 4, the contours of constant loudness as presented by Plate-to-Plate Music Electronics is illustrated. These contours demonstrate that the frequency response of the human ear varies as a function of the loudness of the sound being detected. In particular, these contours show that at low volume levels, both the high frequency response and the low frequency response of the human ear are reduced. Thus the contours define the problem to be address by the invention, in that it is desirable to retain the high and low frequency response of the ear by some means even at low volume. Of course, in small guitar amplifier systems with the resonance described herein, the low frequency response is not generally the problem. However, given the fact that the high frequency response of the single speaker in the amplifier is strongly limited, and compounding that with the fact that at low volumes the high frequency response of the ear is also limited, it is clearly desirable to enhance the high frequency power transferred to the speaker when the attenuation invention is in use. Supporting evidence for this premise is seen in almost all commercial guitar amplifiers on the market, which incorporate a brightness function to enhance the high frequency output of the amplifier. Loudness functions, which are often seen in high fidelity equipment and enhance the low frequency response at low volumes, are almost never included in guitar amplifiers for the reasons outlined herein.

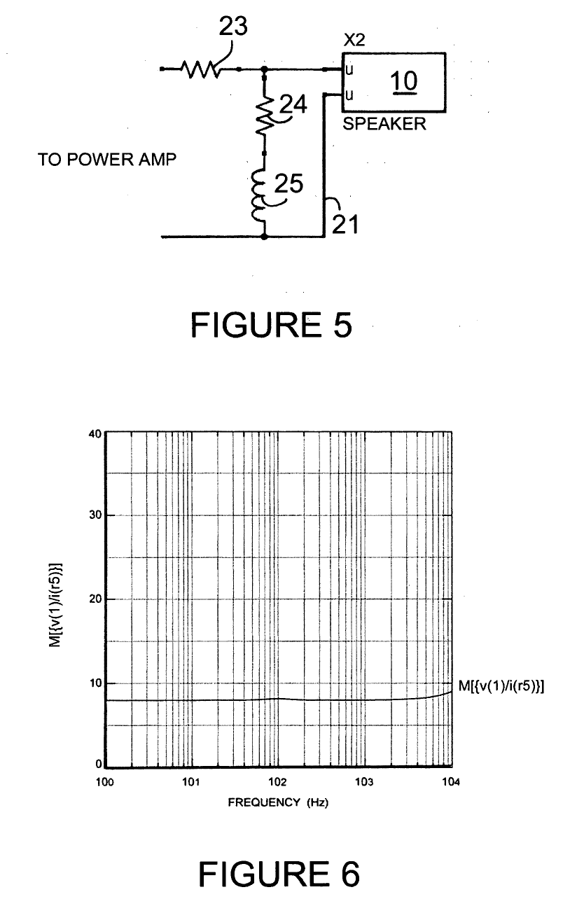

Referring now to FIG. 5, an embodiment in accordance with the present invention is illustrated of an attenuation circuit 21 for a single attenuation level. Attenuation circuit 21 includes three elements, a resistor 23 in connected series with speaker 10, and a resistor 24 and an inductor 25 are connected in parallel with speaker 10. A simulation of the impedance of attenuation circuit 21, done in a TopSpice simulator, is illustrated graphically in FIG. 6. For simulation purposes, in attenuation circuit 21 resistor 23 is equal to 6.8 ohms, resistor 24 is equal to 1.5 ohms, and inductor 25 is equal to 70 microhenries. It is evident from FIG. 6 that one objective of the embodiment has been met with attenuation circuit 21 in that the impedance is resistive and equal to 8 ohms over the entire frequency range of interest.

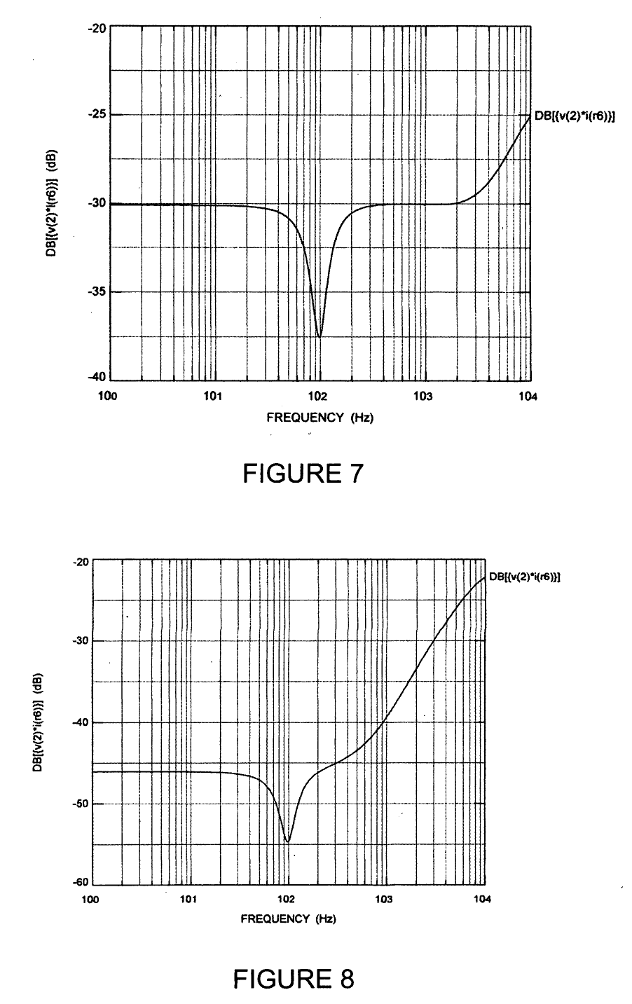

Referring additionally to FIG. 7, the simulated power transferred to speaker 10 through attenuation circuit 21 is illustrated graphically. It is apparent form the simulation that attenuation circuit 21 achieves an attenuation of approximately 30 dB, and significantly enhances the high frequency power transferred to speaker 10. This achieves the other objective of the invention which is to provide significant attenuation of the power delivered to the speaker while enhancing the high frequency response for improved “attack” and a clear sound at reduced volumes.

Referring additionally to FIG. 8, the simulated power transferred to speaker 10 for a modified embodiment of attenuation circuit 21 is illustrated. In the modified embodiment resistor 23 is equal to 7.5 ohm, resistor 24 is equal to 0.5 ohm, and inductor 25 is equal to 100 microhenries. For this modified embodiment the attenuation is almost equal to 50 dB with an increased high frequency enhancement to compensate for the reduced ear response at the lower output levels. Here it will be understood by those skilled in the art that either or both resistors 23 and 24 could be a potentiometer and inductance 25 could also be adjustable to provide a smooth and continuous shift between two chosen amounts of power attenuation. Further, resistors 23 and 24 (and inductor 26 if desired) could be physically connected so as to be varied simultaneously to present a constant input impedance for the attenuation circuit.

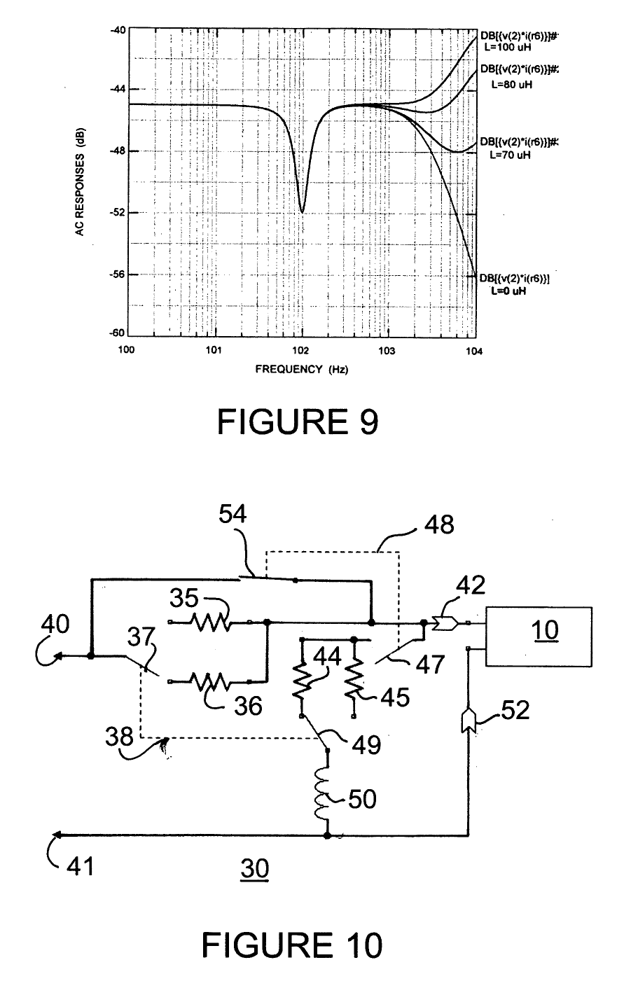

Referring additionally to FIG. 9, the results of several simulations of enhanced high frequency power transferred to the speaker for different values of inductor 25 of attenuation circuit 21 are illustrated. These simulations illustrate how the high frequency enhancement and “action” of the amplifier may be varied by choosing appropriate values of inductor 25. It will of course be understood by those skilled in the art that an adjustable inductor could be used as inductor 25 to provide a smooth and continuous change between chosen limits of high frequency enhancement and “action” of the amplifier.

By now it should be evident to one skilled in the art that there are numerous combinations of passive electrical components, e.g. resistors, fixed or variable, and inductors, fixed or variable, that can achieve the desired goals of a constant fixed impedance matching the nominal impedance of a direct coupled amplifier output stage, a large, well characterized attenuation, and an enhanced high frequency output, as well as smooth variations between chosen limits of these characteristics.

A circuit diagram of a preferred embodiment of an attenuation circuit 30 in accordance with the present invention is illustrated in FIG. 10. Attenuation circuit 30 includes two series resistors 35 and 36 one end of either being alternatively connected by one pole 37 of a double-pole double-throw level switch 38 to an attenuation circuit input terminal 40. The opposite ends of both series resistors 35 and 36 are connected directly to a speaker input terminal 42. One end of both of two parallel resistors 44 and 45 is connected to speaker input terminal 42 through one pole 47 of a double-pole double-throw bypass switch 48. One of the opposite ends of parallel resistor 44 or parallel resistor 45 is alternatively connected by a second pole 49 of level switch 38 to one end of an inductor 50. The opposite end of inductor 50 is connected to a directly coupled second speaker input terminal 52 and a second attenuation circuit input terminal 41. A second pole 54 of bypass switch 48 is connected across series resistors 35 and 36, between attenuation circuit input terminal 40 and speaker input terminal 42, thus effectively shorting out whichever series resistor 35 or 36 is connected into the circuit.

Thus, level switch 38 connects either series resistor 36 and parallel resistor 44 into attenuation circuit 30 in a first mode (illustrated in FIG. 10) or series resistor 35 and parallel resistor 45 into attenuation circuit 30 in a second mode. Also, bypass switch 48 effectively bypasses or removes attenuation circuit 30 from the system and connects attenuation circuit input terminal 40 directly to speaker input terminal 42.

In this preferred embodiment, level switch 38 is connected so as to switch the series and parallel resistors into and out of the speaker path so as to present a constant impedance at the attenuation circuit input terminals 40 and 41 while varying the attenuation of attenuation circuit 30. In yet another variation of the preferred embodiment, the resistance values of the series and parallel resistors are chosen to deliver attenuations of 30 and 50 dB as described in FIGS. 6, 7, and 8. While passive electrical components in this embodiment include resistors 35, 36, 44, and 45, it will be understood by those skilled in the art that these resistors could be a potentiometer or could be replaced by a pair of potentiometers to provide a smooth and continuous shift between two chosen amounts of power attenuation. Further, the potentiometers could be physically connected so as to be varied simultaneously to present a constant input impedance for the attenuation circuit.

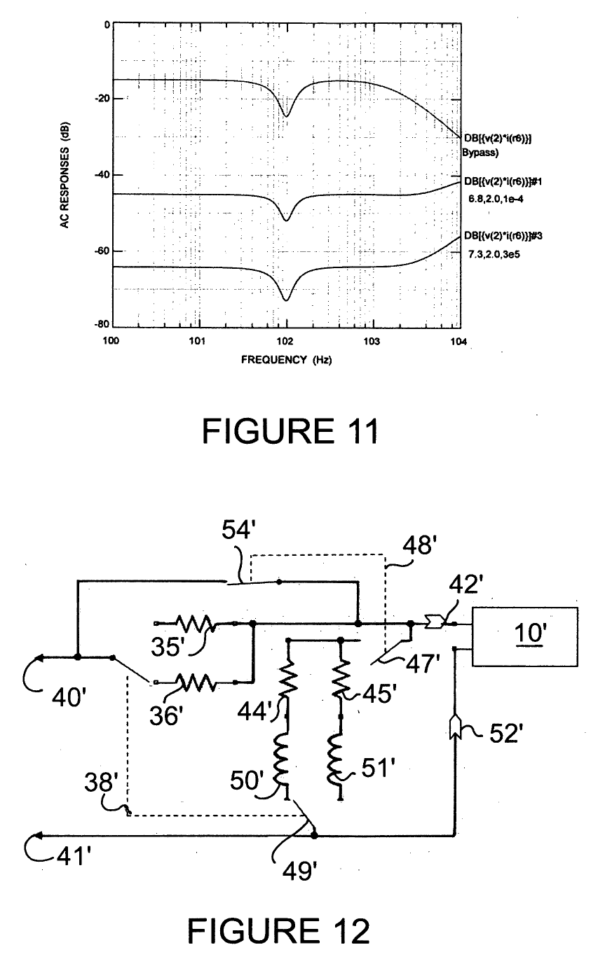

Simulated power transferred to speaker 10 is illustrated in FIG. 11 for the two modes or positions of level switch 38. The desirable characteristic attenuation and enhanced high frequency response are clearly illustrated.

Another embodiment of an attenuator circuit 30′ in accordance with the present invention is illustrated in FIG. 12. In this embodiment components similar to components included in the embodiment of FIG. 10 are designated with similar numerals and a prime is added to all numerals to indicate the different embodiment. In this embodiment one end of inductor 50′ is connected directly to the free end of resistor 44′ and one end of a second inductor 51′ (added in this embodiment) is connected directly to the free end of resistor 45′. The opposite ends of inductors 50′ and 51′ are alternatively connected to the directly coupled second speaker input terminal 52 and second attenuation circuit input terminal 41 by the second pole of level switch 38′. Thus, when level switch 38′ is moved from one mode to the other it not only changes the parallel resistance but also changes the parallel inductance.

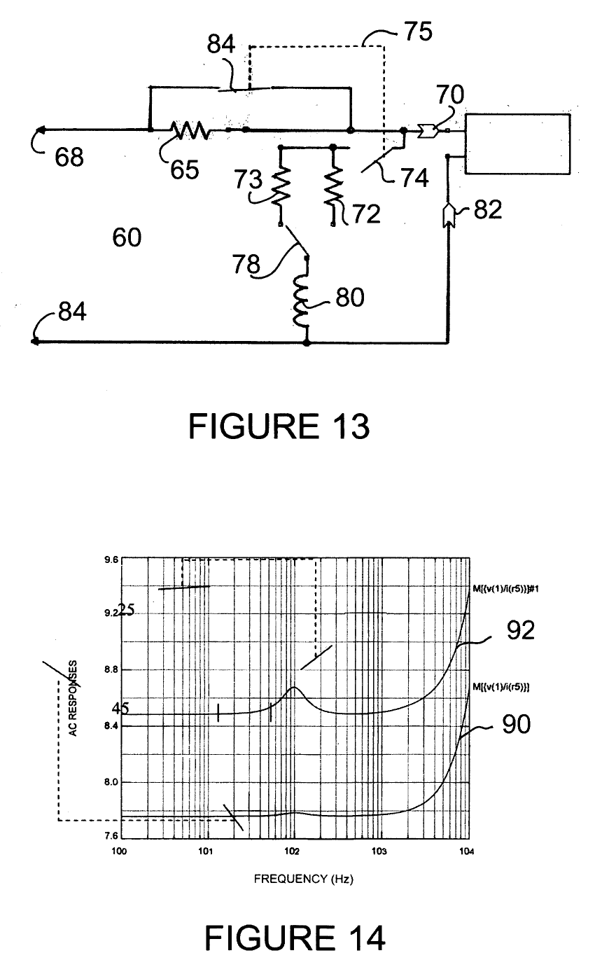

Turning to FIG. 13 an embodiment of an attenuation circuit 60, is illustrated as a means of reducing the parts count. Attenuation circuit 60 includes only a single series resistor 65 directly connected between an attenuation circuit input terminal 68 and a speaker input terminal 70. One end of both of two parallel resistors 72 and 73 is alternatively connected to or disconnected from speaker input terminal 70 through one pole 74 of a double-pole double-throw bypass switch 75. The opposite end of either parallel resistor 72 or parallel resistor 73 is alternatively connected through the pole of a single-pole double-throw level switch 78 to one end of an inductor 80. The opposite end of inductor 80 is connected to a second speaker input terminal 82 and to a directly coupled input terminal 84 of attenuator circuit 60. Also, a second pole 84 of bypass switch 75 is connected between input terminal 68 of attenuator circuit 60 and input terminal 70 of speaker 10 thus effectively shorting out series resistor 65 when operated.

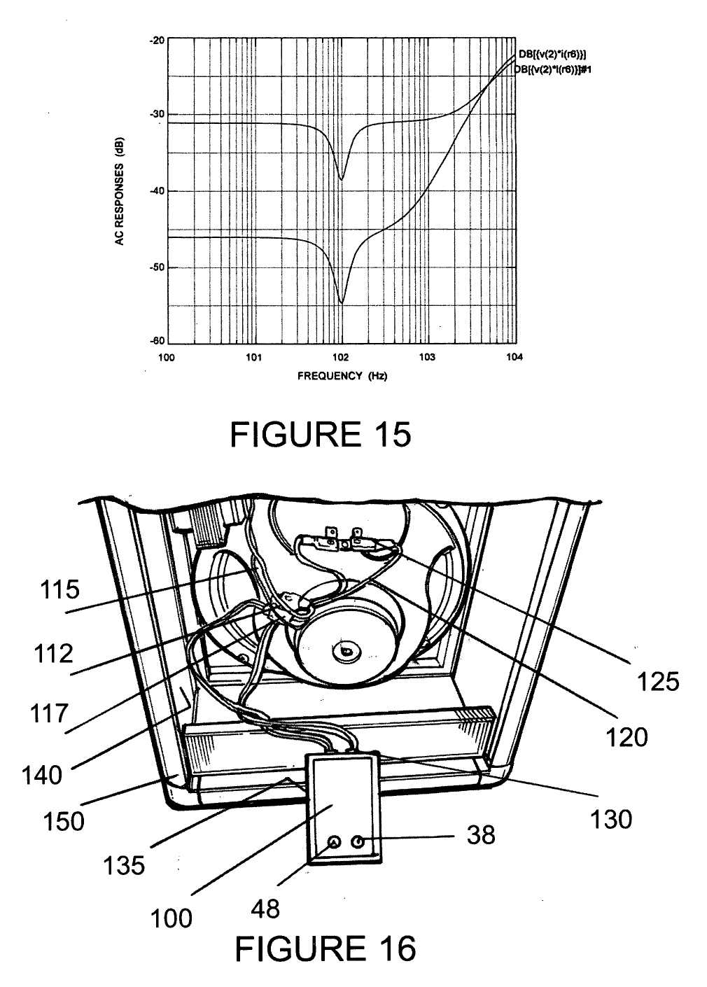

A simulation of the impedances of the circuit 60 is illustrated in FIG. 14 for both level positions or modes of level switch 78. The input impedance of attenuation circuit 60 with series resistor 65 equal to 7.5 ohm and parallel resistor 72 equal to 1.5 ohm is depicted by curve 90. With parallel resistor 73 (equal to 0.5 ohms) switched into the circuit, the input impedance is depicted by curve 92. It can be seen that the input impedance between the two modes varies by only approximately 10%. The attenuated power for the two parallel resistor switched configurations is shown in FIG. 15, whereby the attenuation provided for the two switch positions is 32 dB and 46 dB.

Turning to FIG. 16, a reduction to practice is illustrated pictorially for the preferred embodiment of attenuation circuit 30 of FIG. 10. Attenuation circuit 30 is enclosed in a plastic enclosure 100, approximately the size of a deck of playing cards. Level switch 38 and bypass switch 48 are mounted in a top panel of enclosure 100. Input leads with male spade lugs 112 connect to guitar amplifier speaker leads 115, which have female spade lugs 117 and are first removed from the speaker itself and then inserted onto male spade lugs 112. Attenuator output leads 120 with female spade lugs are attached to the speaker male spade lugs 125 on the speaker itself. Attenuator input and output leads 112 and 120 extend through enclosure 100 using strain reliefs 130. A Velcro attachment 135 is mounted with adhesive to enclosure 100 and can be mated to a Velcro attachment 140 on amplifier cabinet 150 to attach enclosure 100 securely to amplifier cabinet 150.

Thus, it can be seen that the disclosed attenuation circuits in accordance with the present invention provide a new and improved output attenuator that alleviates the muddy sound and poor attack commonly seen in guitar amplifiers played at low volume. Further, the new and improved circuitry presents a constant impedance to the output stage of a guitar amplifier to improve the efficiency and safety of operation of the output stage when operated at maximum power to introduce output distortion and improve the sound of the guitar amplifier.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An attenuation circuit adapted to be electrically connected between an output stage of a guitar amplifier and a speaker, the attenuation circuit comprising a plurality of passive electrical components connected to present a constant resistive impedance to said output stage and to attenuate power delivered from the output stage to the speaker.

2. An attenuation circuit as claimed in claim 1 wherein the plurality of passive electrical components are further connected to enhance high frequency power delivered to the speaker.

3. An attenuation circuit as claimed in claim 2 wherein the plurality of passive electrical components are further connected so that the power attenuation is variable

4. An attenuation circuit as claimed in claim 3 further including a switch connected to at least some of the passive electrical components to discretely control the power attenuation by means of the switch.

5. An attenuation circuit as claimed in claim 3 wherein a potentiometer is included in the passive electrical components and is connected to provide a smoothly controlled power attenuation by means of the potentiometer

6. An attenuation circuit as claimed in claim 2 further including a switch connected to at least some of the passive electrical components and an amount of high frequency power delivered to the speaker is controlled by the switch.

7. An attenuation circuit as claimed in claim 2 wherein at least some of the passive electrical components are variable and the amount of high frequency power delivered to the speaker is continuously controlled by the variable components.

8. An attenuation circuit as claimed in claim 1 wherein the plurality of passive electrical components includes a first resistance adapted to be connected in series between the output stage of the guitar amplifier and the speaker and a series connected second resistance and inductance adapted to be connected in parallel with the speaker.

9. An attenuation circuit as claimed in claim 8 wherein an input impedance of the first resistance and the series connected second resistance and inductance matches a nominal impedance of the speaker.

10. An attenuation circuit as claimed in claim 9 wherein the input impedance is predominantly resistive.

11. An attenuation circuit as claimed in claim 8 wherein the first resistance includes a variable resistor.

12. An attenuation circuit as claimed in claim 8 wherein the second resistance includes a variable resistor.

13. An attenuation circuit as claimed in claim 8 wherein both the first and the second resistances are variable and connected to be varied simultaneously to present a constant input impedance for the attenuation circuit.

14. An attenuation circuit as claimed in claim 8 wherein the plurality of passive components includes a plurality of first resistors with different resistance values, a plurality of second resistors with different resistance values, and a switch coupled together, and the first resistance and the second resistance are variable by operating the switch to connect different ones of the plurality of first resistors and different ones of the plurality of second resistors in series and parallel into the attenuation circuit.

15. An attenuation circuit as claimed in claim 14 wherein the plurality of passive components includes a plurality of different inductors and the inductance is varied by switching different inductors into the attenuation circuit.

16. An attenuation circuit as claimed in claim 15 wherein the plurality of first resistors, the plurality of second resistors, and the switch are interconnected to vary the first resistance and the second resistance simultaneously.

17. A method for operating a guitar amplifier and speaker in conjunction with the attenuation circuit of claim 1, comprising the steps of:
providing the attenuation circuit of claim 1, connecting input terminals of the attenuation circuit to an output stage of the guitar amplifier and output terminals of the attenuation circuit to the speaker;
operating an output stage of said amplifier at maximum output power; and
using the attenuation circuit, attenuating the output of the output stage before applying to the speaker.

18. An attenuation circuit adapted to be electrically connected between an output stage of a guitar amplifier and a speaker, the attenuation circuit comprising:
a plurality of passive components including a series resistor, a parallel resistor, and an inductance;
the series resistor, the parallel resistor, and the inductance being coupled to connect the series resistor in series between the output stage of the guitar amplifier and the speaker, to connect the parallel resistor in series with the inductance, and to connect the series connected parallel resistor and the inductance in parallel with the speaker to present a constant resistive impedance to said output stage and to attenuate power delivered from the output stage to the speaker.

19. An attenuation circuit as claimed in claim 18 wherein the plurality of passive components further includes a plurality of series resistors and a plurality of parallel resistors, and the plurality of series resistors, the plurality of parallel resistors, and the switch are interconnected to provide at least two levels of attenuation.

20. An attenuation circuit as claimed in claim 18 wherein the plurality of passive components further includes a plurality of series resistors, a plurality of parallel resistors, and a plurality of inductors, and the plurality of series resistors, the plurality of parallel resistors, and the plurality of inductors are interconnected to provide at least two levels of attenuation and high frequency power.

21. A method for operating a guitar amplifier and speaker in conjunction with the attenuation circuit of claim 18, comprising the steps of:
providing the attenuation circuit of claim 18, connecting input terminals of the attenuation circuit to an output stage of the guitar amplifier and output terminals of the attenuation circuit to the speaker;
operating an output stage of said amplifier at maximum output power; and
using the attenuation circuit, attenuating the output of the output stage before applying to the speaker.

22. An attenuation circuit adapted to be electrically connected between an output stage of a guitar amplifier and a speaker, the attenuation circuit comprising:
a plurality of passive electrical components connected to present a constant resistive impedance to said output stage and to attenuate power delivered from the output stage to the speaker in at least two levels;
the plurality of passive components including a plurality of series resistors with different resistance values, a plurality of parallel resistors with different resistance values, an inductance, and a level switch coupled together;
the level switch having a first mode of operation for providing a first level of attenuation and a second mode of operation for providing a second level of attenuation;
the level switch, the plurality of series resistors, the plurality of parallel resistors, and the inductance being coupled to connect a first one of the plurality of series resistors in series between the output stage of the guitar amplifier and the speaker and to connect a first one of the plurality of parallel resistors in series with the inductance and the series connected first one of the plurality of parallel resistors and the inductance in parallel with the speaker in the first mode of operation; and
the level switch, the plurality of series resistors, the plurality of parallel resistors, and the inductance being coupled to connect a second one of the plurality of series resistors in series between the output stage of the guitar amplifier and the speaker and to connect a second one of the plurality of parallel resistors in series with the inductance and the series connected second one of the plurality of parallel resistors and the inductance in parallel with the speaker in the second mode of operation.
